(19) United States
(12) Patent Application Publication
(10) Pub. No.: US 2022/0121937 A1
(43) Pub. Date: Apr. 21, 2022

(54) SYSTEM AND METHOD FOR DYNAMIC QUANTIZATION FOR DEEP NEURAL NETWORK FEATURE MAPS

(71) Applicant: Samsung Electronics Co., Ltd., Suwon-si (KR)

(72) Inventors: Chang Su, Foothill Ranch, CA (US); Tien C. Bau, Irvine, CA (US); Arthita Ghosh, Los Angeles, CA (US)

(21) Appl. No.: 17/443,666

(22) Filed: Jul. 27, 2021

Related U.S. Application Data
(60) Provisional application No. 63/094,648, filed on Oct. 21, 2020.

(51) Int. Cl. G06N 3/08; G06N 3/04; G06N 3/10

(52) U.S. Cl. CPC G06N 3/08; G06N 3/10; G06N 3/0472

(57) ABSTRACT

A method includes processing, using at least one processor of an electronic device, input data using a first layer of a neural network to generate a feature map. The method also includes representing, using the at least one processor, feature data of the feature map using index values. The index values correspond to multiple records of a look up table (LUT), and the records of the LUT represent a non-uniform distribution of quantization levels of the feature map. The method further includes storing, using the at least one processor, the index values in a memory of the electronic device. The method also includes regenerating, using the at least one processor, the feature data of the feature map by cross-referencing the index values with the LUT. In addition, the method includes processing, using the at least one processor, the feature data using a second layer of the neural network.

### CROSS-REFERENCE TO RELATED APPLICATION AND PRIORITY CLAIM

This application claims priority under 35 U.S.C. § 119(e) to U.S. Provisional Patent Application No. 63/094,648 filed on Oct. 21, 2020, which is hereby incorporated by reference in its entirety.

### TECHNICAL FIELD

This disclosure relates generally to machine learning systems. More specifically, this disclosure relates to a system and method for dynamic quantization for deep neural network feature maps.

### BACKGROUND

In consumer devices that use deep neural networks (DNNs), the representation of DNN feature maps as single precision floating point values is prohibitive in terms of the required hardware computational and storage costs. In some cases, quantization can be used to reduce the computational and storage costs. However, quantization can reduce precision, which can lead to quantization errors that cause artifacts and/or loss of performance.

### SUMMARY

This disclosure provides a system and method for dynamic quantization for deep neural network feature maps.

In a first embodiment, a method includes processing, using at least one processor of an electronic device, input data using a first layer of a neural network to generate a feature map. The method also includes representing, using the at least one processor, feature data of the feature map using index values. The index values correspond to multiple records of a look up table (LUT), and the records of the LUT represent a non-uniform distribution of quantization levels of the feature map. The method further includes storing, using the at least one processor, the index values in a memory of the electronic device. The method also includes regenerating, using the at least one processor, the feature data of the feature map by cross-referencing the index values with the LUT. In addition, the method includes processing, using the at least one processor, the feature data using a second layer of the neural network.

In a second embodiment, an electronic device includes at least one memory configured to store instructions. The electronic device also includes at least one processing device configured when executing the instructions to process input data using a first layer of a neural network to generate a feature map. The at least one processing device is also configured when executing the instructions to represent feature data of the feature map using index values. The index values correspond to multiple records of an LUT, and the records of the LUT represent a non-uniform distribution of quantization levels of the feature map. The at least one processing device is further configured when executing the instructions to store the index values in the at least one memory. The at least one processing device is also configured when executing the instructions to regenerate the feature data of the feature map by cross-referencing the index values with the LUT. In addition, the at least one processing device is configured when executing the instructions to process the feature data using a second layer of the neural network.

In a third embodiment, a non-transitory machine-readable medium contains instructions that when executed cause at least one processor of an electronic device to process input data using a first layer of a neural network to generate a feature map. The medium also contains instructions that when executed cause the at least one processor to represent feature data of the feature map using index values. The index values correspond to multiple records of an LUT, and the records of the LUT represent a non-uniform distribution of quantization levels of the feature map. The medium further contains instructions that when executed cause the at least one processor to store the index values in a memory of the electronic device. The medium also contains instructions that when executed cause the at least one processor to regenerate the feature data of the feature map by cross-referencing the index values with the LUT. In addition, the medium contains instructions that when executed cause the at least one processor to process the feature data using a second layer of the neural network.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example neural network that uses look up tables (LUTs) between layers according to this disclosure;

FIG. 3 illustrates example details of the use of LUTs in the neural network of FIG. 2 according to this disclosure;

FIGS. 4A and 4B illustrate example charts showing distributions of data in a feature map according to this disclosure;

FIG. 5 illustrates an example process for estimating and revising the records of an LUT according to this disclosure; and

FIG. 6 illustrates an example method for dynamic quantization for neural network feature maps according to this disclosure.

### DETAILED DESCRIPTION

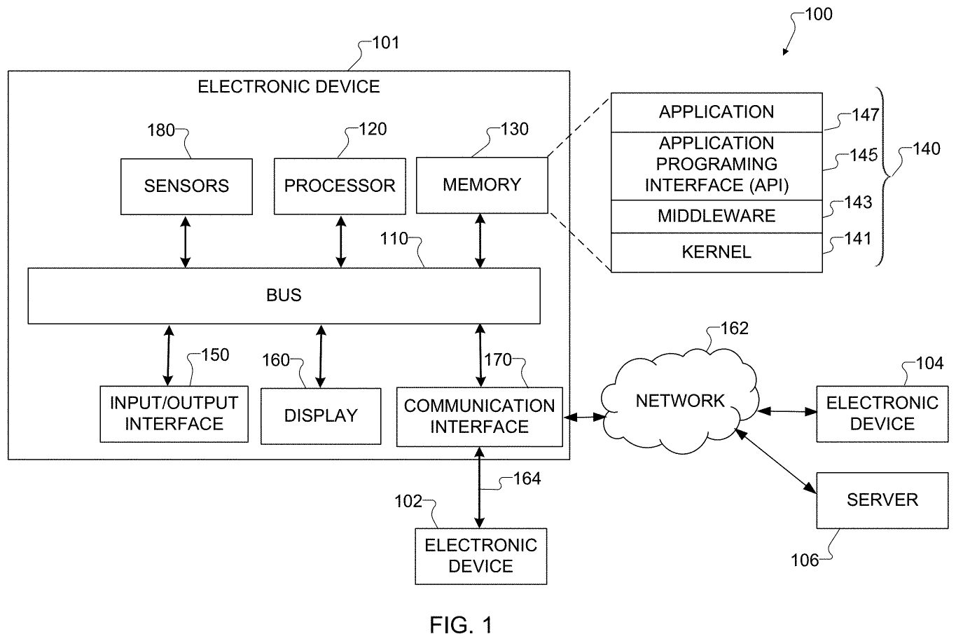

FIGS. 1 through 6, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As previously noted, in consumer devices that use deep neural networks (DNNs), the representation of DNN feature maps as single precision floating point values is prohibitive in terms of hardware computational and storage costs. Approximating these floating point values with reduced precision representations (often referred to as quantization) results in fixed point DNNs for which deployment is feasible and far more efficient. Research in DNN feature map quantization has heavily focused on approximation via uniformly-distributed quantization levels, but this is a model that completely disregards the underlying distribution of feature maps.

Current research in DNN quantization is predominantly focused on maintaining accuracy of the classification models despite the loss in precision. Effective quantization of super-resolving DNN models is relatively unexplored as it requires studying the loss in perceptual quality and the appearance of artifacts, which are harder to quantify using standard distortion metrics. In applications such as classification, detection, and recognition, there is a progressive reduction of feature map size within the network. Even for applications with dense prediction (such as segmentation) there is no increase in size of the feature maps.

In this respect, super-resolution is unique since there is a gradual scale-up of feature maps in the network, which makes it even more useful to quantize the network feature maps. Along with reducing the network size (in terms of depth of feature maps), quantization can help to reduce or minimize the storage needed during inferencing at every layer in the deployment phase. However, conventional quantization techniques reduce precision, which can lead to quantization errors and cause artifacts and loss of performance. For example, optimal distribution of quantization levels for DNN feature maps are highly non-uniform. Existing quantization methods estimate fixed step sizes with uniformly-distributed quantization levels, but these uniform step sizes do not accurately reflect the nature of the actual distribution of the DNN feature maps. Thus, retention of delicate textures is often lost in uniform scaling-based quantization schemes.

This disclosure provides systems and methods for dynamic quantization for deep neural network feature maps. The disclosed systems and methods utilize look up tables (LUTs) between layers of deep neural networks to store distributions of quantization levels for feature maps in a memory-efficient manner. Data records in each LUT can approximate any distribution more closely than uniform scaling techniques. Note that while some of the embodiments discussed below are described in the context of deep neural networks, this is merely one example, and it will be understood that the principles of this disclosure may be implemented in any number of other suitable contexts.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more of a central processing unit (CPU), an application processor (AP), or a communication processor (CP). The processor 120 is able to perform control on at least one of the other components of the electronic device 101 and/or perform an operation or data processing relating to communication. In some embodiments, the processor 120 can be a graphics processor unit (GPU). As described in more detail below, the processor 120 may perform one or more operations to support dynamic quantization for deep neural network feature maps.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for dynamic quantization for deep neural network feature maps as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more cameras.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support dynamic quantization for deep neural network feature maps.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

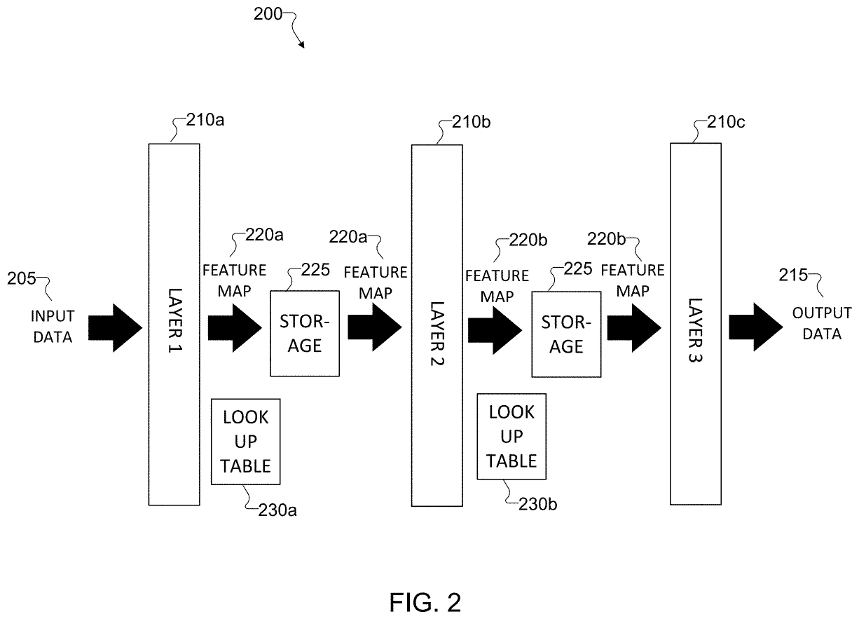

FIG. 2 illustrates an example neural network 200 that uses LUTs between layers according to this disclosure. The neural network 200 can represent any suitable neural network, such as a deep neural network, a convolutional neural network, or the like. For ease of explanation, the neural network 200 is described as being implemented in the electronic device 101 shown in FIG. 1. In some embodiments, the electronic device 101 can represent a television or another consumer device having a display screen. However, the neural network 200 could be implemented in any other suitable electronic device (such as the server 106 of FIG. 1) and in any other suitable system.

As shown in FIG. 2, the neural network 200 receives and processes input data 205 using multiple layers 210a-210c to generate output data 215. The electronic device 101 can obtain the input data 205, which is to be processed using the neural network 200, from any suitable source(s). In some embodiments, the input data 205 represents data associated with one or more images or videos, such as one or more images or videos captured using one or more imaging sensors 180. However, this is merely one example, and the input data 205 can represent other suitable type(s) of data.

The electronic device 101 processes the input data 205 using the layers 210a-210c of the neural network 200 to generate the output data 215. The layers 210a-210c can represent any suitable layers used in a neural network, such as convolutional layers, deconvolutional layers, sigmoid layers, cross-correlation layers, upsampling layers, downsampling layers, and the like. While the neural network 200 is shown with three layers 210a-210c, this is merely for ease of illustration. Other embodiments could include other numbers of layers. The output data 215 represents any suitable data that has been processed by the neural network 200. In some embodiments, the output data 215 represents processed image or video data that is provided for display on a screen, such as a television screen or a display of another electronic device. However, the output data 215 may be used in any other suitable manner.

The output of some neural network layers is commonly referred to as a feature map. A feature map represents intermediary data that is transferred between network layers. In this example, the electronic device 101 uses the layers 210a-210b to generate and output corresponding feature maps 220a-220b. That is, the electronic device 101 uses the layer 210a to generate and output the feature map 220a, and the electronic device 101 uses the layer 210b to generate and output the feature map 220b.

Before the electronic device 101 inputs each feature map 220a-220b to the next layer 210b-210c, the feature map 220a-220b can be saved in a storage 225 of the electronic device 101. In some embodiments, the storage 225 may represent the memory 130. For embodiments that are not timing critical, the storage 225 can be off-chip double data rate static random access memory (DDR-SRAM), graphics double data rate static random access memory (GDDR-SRAM), or other types of non-timing critical memory. For embodiments that are timing critical, the storage 225 can be on-chip SRAM, on-chip dynamic random access memory (DRAM), register files, or other types of timing critical memory. In either case, the space for the storage 225 to store each feature map 220a-220b can contribute to the overall hardware cost.

For many neural networks, the hardware costs of storing feature map data generated by the layers of the neural network may be many times higher than storing the neural network itself. This can be due to the fact that a small patch of data in a deeper layer may require a comparatively large data patch from a previous layer. To reduce the amount of space in the storage 225 used to store each feature map 220a-220b, the neural network 200 includes one or more LUTs 230a-230b that are employed between adjacent layers 210a-210c in the neural network 200. As described in greater detail below, the electronic device 101 uses index values stored in records of the LUTs 230a-230b to represent the feature data of each feature map 220a-220b. The records of each LUT 230a-230b represent an optimal distribution scheme of quantization levels of the corresponding feature map 220a-220b. Typically, the optimal distribution is non-uniform.

In the embodiment shown in FIG. 2, each layer 210a-210b that generates a feature map 220a-220b is associated with a corresponding LUT 230a-230b. In some embodiments, the LUT 230a may be the same as the LUT 230b, meaning the LUTs 230a-230b may contain the same records and values (in which case a single LUT might be used). In other embodiments, the LUT 230a may be different from and contain different data than the LUT 230b. This may be the case when the layers 210a-210c are of different types and generate feature maps with different distributions of values. While the neural network 200 is shown with two LUTs 230a-230b, this is merely for ease of illustration. Other embodiments could include other numbers of LUTs. For example, in some embodiments, the electronic device 101 may not use an LUT for a feature map generated by one or more of the layers 210a-210c.

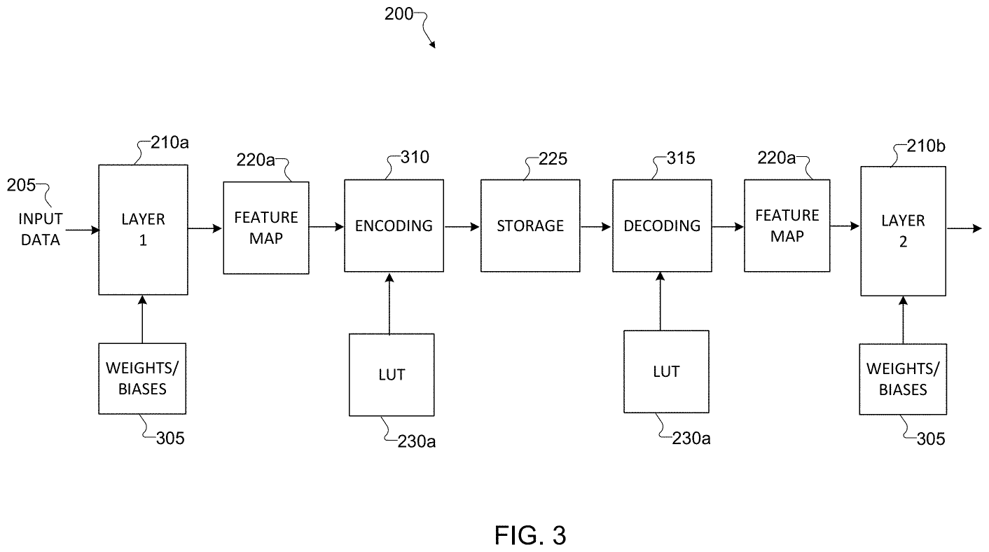

FIG. 3 illustrates example details of the use of LUTs in the neural network 200 of FIG. 2 according to this disclosure. For ease of explanation, the description of FIG. 3 corresponds to operations performed between the adjacent layers 210a and 210b. The description of FIG. 3 can be extended to any other suitable adjacent layers in the neural network 200, such as between the adjacent layers 210b and 210c.

As described above, the electronic device 101 obtains the input data 205 (which is currently de-quantized) and obtains weights (and biases if applicable) 305 associated with the layer 210a. The weights and biases 305 may typically be stored in non-volatile memory of the electronic device 101, such as EEPROM, HDD, SSD, Flash memory, or the like. In implementing the layer 210a, the electronic device 101 applies the weights and biases 305 to the de-quantized input data 205 and generates a resulting feature map 220a, which includes feature data. The feature data of the feature map 220a is content-dependent and thus unpredictable, but the feature data is typically large enough to consume significant amounts of storage if stored unencoded.

To reduce the amount of storage 225 used to store the feature map 220a, the electronic device 101 performs an encoding operation 310 in which the feature data of the feature map 220a is represented using index values. The index values correspond to the records of the LUT 230a. The number of records in the LUT 230a is less than or equal to 2^{b}, where b represents the number of bits in data values contained in the storage 225. Thus, for eight-bit SRAM or DRAM, the number of records in the LUT 230a is less than or equal to 2⁸ or 256. Each record of the LUT 230a is a quantization level for the feature map 220a that is estimated from training data (which may follow any suitable uniform or non-uniform distribution). That is, each record of the LUT 230a represents a range of values that are estimated to be present in the feature map 220a. Together, the records of the LUT 230a represent an optimal quantization scheme for the feature map 220a.

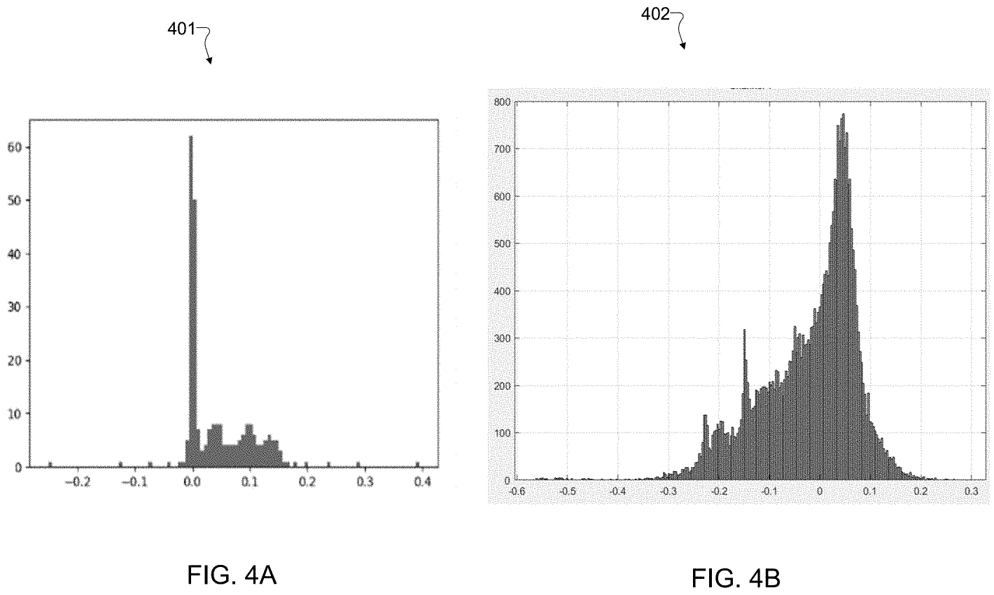

As an example of this, FIGS. 4A and 4B illustrate example charts 401 and 402 showing distributions of data in a feature map according to this disclosure. As shown in FIGS. 4A and 4B, the charts 401 and 402 are histograms of floating point data values in the different feature maps. The chart 401 represents data of one feature map (such as the feature map 220a), and the chart 402 represents data of another feature map (such as the feature map 220b). In FIGS. 4A and 4B, the feature map data in both charts 401 and 402 tends to peak around a value of zero. However, the distribution of data is different between the two charts 401 and 402. Also, the distribution is not uniform across the range of values.

A separate LUT can be generated to represent the data in each of the charts 401 and 402. Each record in the LUT can represent a range of values. For example, considering the chart 401, an LUT implementing a uniform quantization scheme would divide the range of values (such as approximately −0.3 to +0.4) in the chart 401 evenly across the number of records in the LUT. However, such a uniform quantization scheme would tend to lead to significant quantization errors since most of the feature data in the chart 401 is between 0.0 and +0.2, and there is a significant peak around 0.0. In contrast, an LUT exhibiting a non-uniform distribution of quantization levels for the chart 401 could have several records representing values in narrow ranges around 0.0 (such as −0.01 to +0.01) and might have only one record representing a much broader (but sparsely used) range of values between +0.3 and +0.4.

In accordance with these principles, the LUT 230a can store an optimal non-uniform distribution of quantization levels for the feature map 220a. Quantization reduces hardware costs because the quantization represents the feature data with shorter (such as word-length) index values, which significantly reduces the amount of storage. Of course, quantization is an approximation that reduces precision, which can lead to quantization errors. However, the quantization scheme of the LUT 230a is optimized with a non-uniform distribution of quantization levels, thereby maintaining quantization errors at an acceptably low level. Stated differently, the average quantization error (the difference between actual and quantized values) is significantly lower using the LUT 230a than by using a uniform scaling-based quantization. Uniform scaling ignores the underlying non-uniformity in distribution of values in neural network feature maps, which is a property that is better approximated using the LUT 230a.

Turning again to the operations shown in FIG. 3, the electronic device 101 performs the encoding operation 310 to represent the floating point feature data of the feature map 220a as fixed point index values (thereby quantizing the feature map data into smaller data) based on the records of the LUT 230a. The shorter-length (such as eight-bit) index values are efficiently stored in the storage 225. Later, when the electronic device 101 is ready to implement the layer 210b, the electronic device 101 performs a decoding operation 315 using the quantized index values stored in the storage 225. In the decoding operation 315, the electronic device 101 reads the index values from the storage 225 and performs an inverse quantization to regenerate the floating point feature data (thereby restoring the bit precision) of the feature map 220a by cross-referencing the index values with the LUT 230a. The regenerated feature map 220a can be used for a more accurate computation in the next layer 210b.

The operations in FIG. 3 correspond to operations performed between the adjacent layers 210a and 210b, which involves the LUT 230a. As shown in FIG. 2, multiple LUTs 230a-230b may be used after multiple layers 210a-210b in the network 200. In other embodiments, a single LUT may be shared among multiple layers in the network 200. For example, two or more of the layers 210a-210c in the network 200 can be logically combined to form a group. The feature maps from a group can be pooled together as scalar members of a set. Several sets of feature maps can be generated, each from a specific group of layers. In such a case, the LUT corresponding to every set contains the quantization levels approximating the underlying distribution of feature maps belonging to that set.

Although FIGS. 2 through 4B illustrate one example of a neural network 200 that uses LUTs and related details, various changes may be made to FIGS. 2 through 4B. For example, while shown as a specific sequence of operations, various operations shown in FIGS. 2 through 4B could overlap, occur in parallel, occur in a different order, or occur any number of times (including zero times). Also, the specific operations shown in FIGS. 2 through 4B are examples only, and other techniques could be used to perform each of the operations shown in FIGS. 2 through 4B.

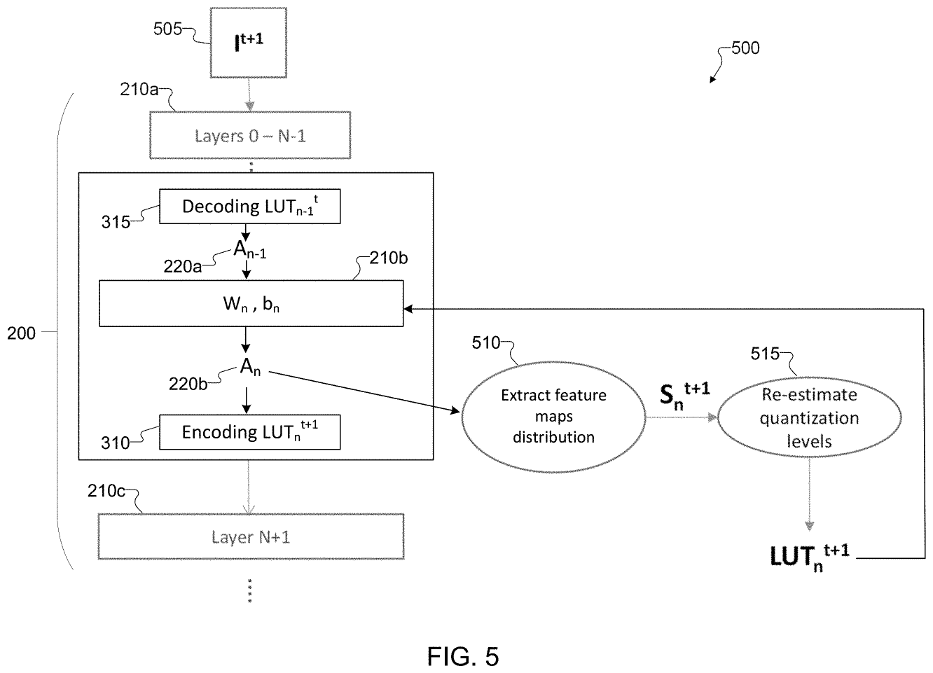

FIG. 5 illustrates an example process 500 for estimating and revising the records of an LUT according to this disclosure. During the process 500, feature map values for the records of the LUT can be revised or re-estimated based on new training data. For ease of explanation, the process 500 shown in FIG. 5 is described as involving the use of the neural network 200 and the LUT 230a shown in FIGS. 2 and 3 and the electronic device 101 shown in FIG. 1. However, the process 500 shown in FIG. 5 could be used with any other suitable electronic device (such as the server 106 of FIG. 1) and in any other suitable system.

The process 500 is performed to minimize errors between a given set of data and its quantized counterpart. The process 500 statistically analyzes the feature data generated by different layers of the neural network 200 and obtains the statistic distributions of the data. The process 500 nonlinearly designs boundaries and reconstruction values according to these data distributions.

As shown in FIG. 5, in the process 500, the electronic device 101 obtains training data 505 (identified as I^{t+1}). Here, t represents an iteration of the process 500. In some embodiments, the training data 505 is image data that is super-resolved by the neural network 200. Once the electronic device 101 obtains the training data 505, the electronic device 101 implements the neural network 200, which includes multiple layers 210a-210c. Each layer 210a-210c includes one or more weights Wₙ and/or bias parameters bₙ. Here, n represents a layer 210a-210c of the neural network 200. In the neural network 200, the input to the layer 210b is the feature map 220a of the previous layer 210a (identified as Aₙ₋₁), which is regenerated after performing a decoding operation 315 using LUTₙ₋₁^{t}. The output of the layer 210 is the feature map 220b (identified as Aₙ).

To estimate LUTₙ^{t+1} (which is the LUT used for the encoding operation 310 after the layer 210b), the electronic device 101 performs an iterative process that includes an extraction operation 510 and a re-estimation operation 515. The extraction operation 510 is performed to obtain scalar samples from the feature map 220b. The samples are used to estimate the distribution of feature map values for the layer 210b (or a group of layers if the layers are grouped together). The output of the extraction operation 510 is an array Sₙ^{t+1}, which is a flattened and detached array of output feature map values. The re-estimation operation 515 is performed using the array Sₙ^{t+1} to adjust the quantization boundaries of LUTₙ^{t} into a revised LUTₙ^{t+1}. The operations 510 and 515 are performed iteratively until a stable LUT is achieved. In some embodiments, the iterative process can include minimizing the mean square error (MSE).

Although FIG. 5 illustrates one example of a process 500 for estimating and revising the records of an LUT, various changes may be made to FIG. 5. For example, while shown as a specific sequence of operations, various operations shown in FIG. 5 could overlap, occur in parallel, occur in a different order, or occur any number of times (including zero times). Also, the specific operations shown in FIG. 5 are examples only, and other techniques could be used to perform each of the operations shown in FIG. 5.

The operations and functions shown in FIGS. 2 through 5 can be implemented in an electronic device 101, server 106, or other device in any suitable manner. For example, in some embodiments, the operations shown in FIGS. 2 through 5 can be implemented or supported using one or more software applications or other software instructions that are executed by the processor 120 of the electronic device 101, server 106, or other device. In other embodiments, at least some of the operations shown in FIGS. 2 through 5 can be implemented or supported using dedicated hardware components. In general, the operations shown in FIGS. 2 through 5 can be performed using any suitable hardware or any suitable combination of hardware and software/firmware instructions.

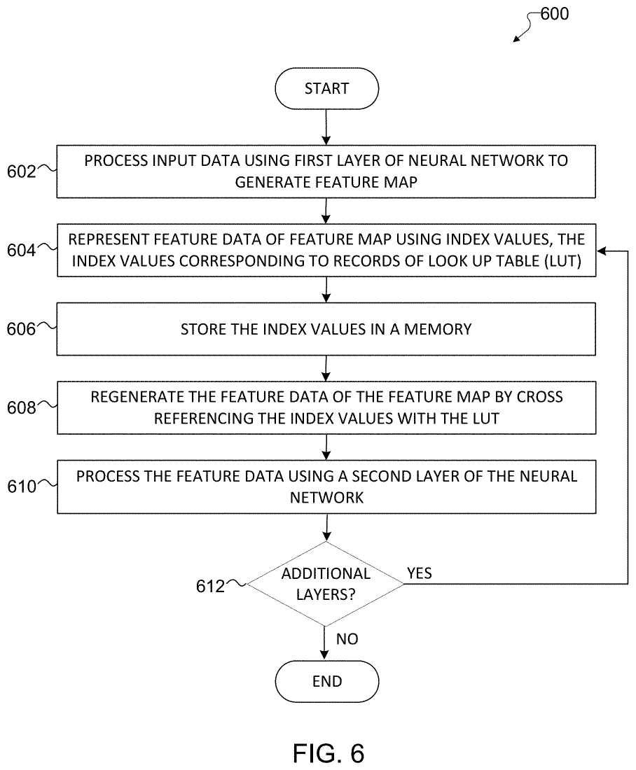

FIG. 6 illustrates an example method 600 for dynamic quantization for neural network feature maps according to this disclosure. For ease of explanation, the method 600 shown in FIG. 6 is described as involving the use of the neural network 200 shown in FIGS. 2 and 3 and the electronic device 101 shown in FIG. 1. However, the method 600 shown in FIG. 6 could be used with any other suitable electronic device (such as the server 106 of FIG. 1) and in any other suitable system.

As shown in FIG. 6, input data is processed using a first layer of a neural network to generate a feature map at step 602. This could include, for example, the electronic device 101 processing the input data 205 using the layer 210a of the neural network 200 to generate the feature map 220a. Feature data of the feature map is represented using index values at step 604. The index values correspond to multiple records of an LUT, where the records of the LUT represent a non-uniform distribution of quantization levels of the feature map. This could include, for example, the electronic device 101 performing the encoding operation 310 to represent the feature map 220a as index values of the LUT 230a. The index values are stored in a memory of the electronic device at step 606. This could include, for example, the electronic device 101 storing the index values in the storage 225.

The feature data of the feature map is regenerated by cross-referencing the index values with the LUT at step 608. This could include, for example, the electronic device 101 regenerating the feature data of the feature map 220a by cross-referencing the index values with the LUT 230a. The feature data is processed at step 610 using a second layer of the neural network. This could include, for example, the electronic device 101 processing the feature data of the feature map 220a using the layer 210b of the neural network 200. An output of the layer 210b can include the feature map 220b. It is determined at step 612 if the neural network includes additional layers. This could include, for example, the electronic device 101 determining if the neural network 200 includes additional layers (e.g., the layer 210c) beyond the layer 210b. If there are additional layers, the method 600 can return to step 604 for processing using the additional layers. In some embodiments, the processing using the additional layers can include using the feature map 220b as an input.

Although FIG. 6 illustrates one example of a method 600 for dynamic quantization for neural network feature maps, various changes may be made to FIG. 6. For example, while shown as a series of steps, various steps in FIG. 6 could overlap, occur in parallel, occur in a different order, or occur any number of times.

It may be helpful to distinguish the use of LUTs in this disclosure from the use of LUTs in conventional activation functions. Some activation functions use LUTs for various purposes while implementing the activation function. In contrast, the LUTs of this disclosure are employed between layers after an activation function (if any) has already been performed and the feature map has been generated. In other words, the LUTs disclosed here are used for storing result information from a layer, not for an intermediate intra-layer purpose.

The LUT quantization techniques disclosed here help to reduce hardware requirements (such as line buffer storage) for neural network model deployment. The disclosed data-driven estimation of quantization levels model the actual distribution of DNN feature maps more closely than uniform scaling.

The disclosed embodiments can be useful in any suitable electronic devices that use fixed point computations instead of floating point computations. To demonstrate the effectiveness of using LUTs between neural network layers in accordance with this disclosure, tests have been conducted in which the feature maps of a super-resolving DNN model have been quantized using two approaches. One approach used a quantization scheme with non-uniform step sizes implemented via LUTs according to this disclosure. The second approach used scale-based feature map quantization with uniform step sizes (the scales are computed per layer). Results of the tests indicate that the approach using the non-uniform data driven scheme implemented via LUTs has better performance than the second approach. More specifically, the approach using the non-uniform data driven scheme results in lower quantization errors (due to a more optimal quantization scheme) and reduced quantization error related artifacts. In addition, the disclosed embodiments can improve retention of delicate textures generated by the super-resolving network, which results in higher perceptual quality.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
processing, using at least one processor of an electronic device, input data using a first layer of a neural network to generate a feature map;
representing, using the at least one processor, feature data of the feature map using index values, the index values corresponding to multiple records of a look up table (LUT), the records of the LUT representing a non-uniform distribution of quantization levels of the feature map;
storing, using the at least one processor, the index values in a memory of the electronic device;
regenerating, using the at least one processor, the feature data of the feature map by cross-referencing the index values with the LUT; and
processing, using the at least one processor, the feature data using a second layer of the neural network.

2. The method of claim 1, wherein each of the records of the LUT includes one of the index values and a group of quantization levels identified by the one index value.

3. The method of claim 1, wherein a size of the LUT corresponds to a bit precision of the memory of the electronic device.

4. The method of claim 1, wherein the memory of the electronic device comprises on-chip dynamic random access memory (DRAM) or static random access memory (SRAM).

5. The method of claim 1, wherein the first layer and the second layer are consecutive layers of the neural network.

6. The method of claim 1, wherein the representation of the non-uniform distribution of quantization levels of the feature map by the records of the LUT is estimated in an iterative training process.

7. The method of claim 1, wherein the input data is associated with one or more images or videos.

8. The method of claim 1, further comprising:
processing, using the at least one processor, second input data using a third layer of the neural network to generate a second feature map;
representing, using the at least one processor, second feature data of the second feature map using second index values, the second index values corresponding to multiple records of a second LUT, the records of the second LUT representing a non-uniform distribution of quantization levels of the second feature map;
storing, using the at least one processor, the second index values in the memory of the electronic device;
regenerating, using the at least one processor, the second feature data of the second feature map by cross-referencing the second index values with the second LUT; and
processing, using the at least one processor, the second feature data using a fourth layer of the neural network.

9. The method of claim 8, wherein the second layer and the third layer are the same layer.

10. An electronic device comprising:
at least one memory configured to store instructions; and
at least one processing device configured when executing the instructions to:
process input data using a first layer of a neural network to generate a feature map;
represent feature data of the feature map using index values, the index values corresponding to multiple records of a look up table (LUT), the records of the LUT representing a non-uniform distribution of quantization levels of the feature map;
store the index values in the at least one memory;
regenerate the feature data of the feature map by cross-referencing the index values with the LUT; and
process the feature data using a second layer of the neural network.

11. The electronic device of claim 10, wherein each of the records of the LUT includes one of the index values and a group of quantization levels identified by the one index value.

12. The electronic device of claim 10, wherein a size of the LUT corresponds to a bit precision of the at least one memory.

13. The electronic device of claim 10, wherein the at least one memory comprises on-chip dynamic random access memory (DRAM) or static random access memory (SRAM).

14. The electronic device of claim 10, wherein the first layer and the second layer are consecutive layers of the neural network.

15. The electronic device of claim 10, wherein the representation of the non-uniform distribution of quantization levels of the feature map by the records of the LUT is estimated in an iterative training process.

16. The electronic device of claim 10, wherein the input data is associated with one or more images or videos.

17. The electronic device of claim 10, wherein the at least one processing device is further configured to:
process second input data using a third layer of the neural network to generate a second feature map;
represent second feature data of the second feature map using second index values, the second index values corresponding to multiple records of a second LUT, the records of the second LUT representing a non-uniform distribution of quantization levels of the second feature map;
store the second index values in the at least one memory;
regenerate the second feature data of the second feature map by cross-referencing the second index values with the second LUT; and
process the second feature data using a fourth layer of the neural network.

18. The electronic device of claim 17, wherein the second layer and the third layer are the same layer.

19. A non-transitory machine-readable medium containing instructions that when executed cause at least one processor of an electronic device to:
process input data using a first layer of a neural network to generate a feature map;
represent feature data of the feature map using index values, the index values corresponding to multiple records of a look up table (LUT), the records of the LUT representing a non-uniform distribution of quantization levels of the feature map;
store the index values in a memory of the electronic device;
regenerate the feature data of the feature map by cross-referencing the index values with the LUT; and
process the feature data using a second layer of the neural network.

20. The non-transitory machine-readable medium of claim 19, wherein each of the records of the LUT includes one of the index values and a group of quantization levels identified by the one index value.
